(19) United States
(12) Patent Application Publication
(10) Pub. No.: US 2015/0377838 A1
(43) Pub. Date: Dec. 31, 2015

(54) CONDUIT LOCATING METHOD AND APPARATUS

(71) Applicants: David A. James, Burnaby (CA); David V. Williamson, Burnaby (CA)

(72) Inventors: David A. James, Burnaby (CA); David V. Williamson, Burnaby (CA)

(21) Appl. No.: 14/315,208

(22) Filed: Jun. 25, 2014

(51) Int. Cl. G01N 29/265

(52) U.S. Cl. CPC G01N 29/265; G01N 2291/045

(57) ABSTRACT

An apparatus for use with at least one associated elongated conduit having first and second axial extremities and for facilitating the identification of the location of the second axial extremity of the associated conduit when presented with the first axial extremity thereof which includes an audio generator having an emitter port having an acoustic output amplitude equal to or greater than 110 dB measured at 2 inches from said emitter port.

### RELATED APPLICATIONS

This application is a continuation of U.S. provisional application 6189298 filed Jun. 25, 2013 having the same inventor.

### FIELD OF THE INVENTION

The present invention relates generally to electrical wiring used in construction and renovation of buildings and, more particularly, to systems for facilitating the installation of interior or exterior electrical wiring in conduits commonly used in commercial and residential buildings. After conduit for the wiring has been installed in the buildings, the invention facilitates the identification of the conduit ends and thereby the determination of the location at which the conduits originate and terminate.

### BACKGROUND OF THE INVENTION

Most modern building employ metallic or plastic conduits to enable electrical wiring protection and easier routing for electrical wiring. These conduits or pipes may end up being buried in walls, floors or ceilings, and may be in a single building, or may span distances between buildings. They may be run in free air, fully encased in concrete, or be underground. The routing of such pipes is rarely obvious. It is of course mandatory that the person installing wiring in such a pipe or conduit knows where the pipe starts and where it ends. The problem is compounded for the installer working in large commercial buildings because there will be hundreds or thousands of such conduits.

The most common method of locating the opposite, or far end of a pipe is to insert a steel ‘fish tape’, and keep pushing it into the conduit until it either jams, or comes out the other end. If the conduit is in free air, or in a typical wall or ceiling, it may be helpful to rattle the tape back and forth, which—if the worker is lucky—may help to locate the approximate routing of the pipe. Often however, this approach does not work, and one or more people must investigate every likely end point of the conduit to see if the fish tape showed up. Sometimes, the fish tape will jam in the conduit, making it impossible to locate the other end of the run. Many times, the tape will catch something in the pipe run and cannot be removed, resulting in several more problems. The fish tape now has to be cut off, causing the loss of the tape; the conduit is now useless due to a fish tape being jammed in it; and the worker still has no idea where the conduit goes. This approach can also be extremely dangerous, in that some pipes may lead into live electrical panels. If the conduit is plastic or ungrounded, the next best path to ground is likely to be through the electrician holding on to the fish tape.

In some cases, the original installer of the conduit may have left a ‘pull string’ in the conduit to assist in later installation of wiring. As handy as this may be, it does little to help locate the other end of the pipe. Jiggling the pull string often has no noticeable effect, even if another worker happens to be near the other end of the pipe, as no noise is generated by the string. It is usually unwise to pull too hard on a pull string, as it may come loose at the far end, making the pull string useless as it disappears into the pipe. If a fish tape is inserted into a pipe with a pull string in it, the fish may get tangled in the pull string, making a bad situation worse.

Other methods used may include yelling into the pipe, or using compressed air or the output of a vacuum cleaner to make some sort of audible noise at the far end. Several patents have been issued in regards to various methods of using sound to locate conduit end points, however none of these are currently on the market, as they have not been commercially viable.

The prior art includes U.S. Pat. No. 6,772,634. In this approach, the transmitter has an acoustic emitter mounted on a flexible stalk (as opposed to being mounted inside the unit), and employs a microprocessor circuit enclosed in a separate enclosure to which the stalk is mounted. The microprocessor sends a coded signal to the emitter, which then sends a coded acoustic signal down the conduit. A major limitation is that the system requires special apparatus to detect this coded signal.

In operation, the emitter is placed in or near one end of a conduit, and turned on. The receiver (which is visually identical to the transmitter) has a similar stalk, but instead has a microphone or other pickup transducer on the end. Another microprocessor is employed that decodes the signal and alerts the user by lighting an LED, or emitting an acoustic signal from an onboard speaker.

The operator takes the receiver to where he suspects the pipe ends and places the pickup proximate to the remote respective pipe end. If, by some chance, the user happens to find the other end of the original pipe, the user can verify that it is the correct one by observing the LED or listening for the tone on the receiver.

The prior art also includes U.S. Pat. No. 8,220,332. This patent differs from the apparatus shown in U.S. Pat. No. 6,772,634 because the apparatus described sends out an apparently louder pulse, has no ‘stalks’, and is not directly connected to the pipe at either end. The emitter has magnets on it to attach it to a junction box.

There are several problems with these approaches:
1. In the case of the structure described in U.S. Pat. No. 6,772,634, the output level is extremely low because the emitter must necessarily be small, as the emitter must be dimensioned and configured to permit the emitter to be inserted into a small diameter pipe. Natural attenuation of the sound in the pipe due to bends, or simply length, would result in a fairly limited range of operation.
2. Accordingly, it will still be quite difficult to locate the other end of a conduit unless the user already knows approximately where it is. Otherwise the user has to check every possible conduit in the building (which could number in the hundreds) and test every possible conduit with the receiver apparatus. Very little time would be saved over the traditional “find the fish tape” method.
3. Neither of these prior art devices can be used to locate conduits that terminate in junction boxes that have been hidden behind drywall, or end inside closed junction boxes and electrical panels. The apparatus of the present system can do this.
4. The prior art units are quite expensive to build, and are unlikely to sell in any appreciable numbers due to the high cost of manufacture.
5. If either the transmitter or receiver malfunctions, or is lost or damaged, or simply has a dead battery, the entire system becomes useless.
6. In the case of the apparatus shown in U.S. Pat. No. 8,220,332, there are several additional problems.
   a. In the case shown in FIG. 7B in the patent, the emitter is shown in a junction box with two pipes, A and B. The emitter is not connected directly to either pipe. As a result, the sound emanating from A and B would be virtually identical, and therefore indistinguishable. A person would be unable to differentiate A and B with this method. In the drawing, A and B both come from a first junction box and both go to a second junction box. The more common usage would be to have A and B in a common junction box at one end, but go to different locations at the other ends. The user would not be able to tell which was which, making the entire system rather useless.
   b. The described magnet attachment method for the emitter would be useless on aluminum or plastic junction boxes, or if the pipe starts in mid-air without going into a junction box.
   c. From experience, we have found that open air operation of an acoustic generator, such as described in U.S. Pat. No. 8,220,332 is annoying, and makes it difficult to locate pipes ending near the emitter, as the direct sound from the emitter is often louder than the sound coming out the far end of the pipe.

The apparatus described in U.S. Pat. No. 6,772,634 includes attachment of the device to the end of a conduit, and sends an audible sound wave down the pipe. The apparatus described in U.S. Pat. No. 8,220,332 can also be attached directly to the conduit; however it too requires special apparatus to detect the sound wave, making it virtually the same as U.S. Pat. No. 6,772,634, along with its attendant problems. In addition, the ‘funnel’ shown as item 910 in U.S. Pat. No. 8,220,332 would be physically too large to fit into many smaller junction boxes.

Additional prior art is shown in the following prior patents: U.S. Pat. No. 4,234,942; U.S. Pat. No. 4,494,224; U.S. Pat. No. 4,584,676; U.S. Pat. No. 4,934,478; U.S. Pat. No. 5,027,644; U.S. Pat. No. 6,003,776; and JPS60243561A.

### SUMMARY OF THE INVENTION

It is an object of the present invention to facilitate the installation of interior electrical wiring in conduits in commercial and residential buildings.

It is also an object of the present invention to facilitate the identification of respective conduit ends and thereby the determination of the location at which the conduits originate and terminate.

Another object of the present invention to provide a method that enables a user to when given a first end of a first conduit, identify the remote second end of that first conduit even if the first conduit has a substantially greater length than was possible heretofore.

The recitation herein of desirable objects which are met by various embodiments of the present invention is not meant to imply or suggest that any or all of these objects are present as essential features, either individually or collectively, in the most general embodiment of the present invention or in any of its more specific embodiments.

The foregoing and other objects, features and advantages of the invention will be apparent from the following more particular description of illustrative embodiments of the invention, as illustrated in the accompanying drawings in which like reference characters refer to the same parts throughout the different views. The drawings are not necessarily to scale, emphasis instead being placed upon illustrating the principles of the invention. Those skilled in the art will understand that the devices and methods specifically described herein and illustrated in the accompanying drawings are non-limiting exemplary embodiments. The features illustrated or described in connection with one exemplary embodiment can be combined with the features of other embodiments. Such modifications and variations are intended to be included within the scope of the present invention.

It is now been found that these and other objects of the present invention may be achieved in an apparatus for use with at least one associated elongated conduit having first and second axial extremities and for facilitating the identification of the location of the second axial extremity of the associated conduit when presented with the first axial extremity thereof which includes an audio generator having an emitter port having an acoustic amplitude output equal to or greater than 110 dB measured at 2 inches from said emitter port.

In some embodiments the apparatus may also include a housing enclosing at least a part of said audio generator, said housing constraining audio output from said audio generator at parts thereof other than said emitter port. Similarly, the apparatus may include a housing enclosing at least a part of the audio generator and the housing further including sound insulating substances therein. The housing may also enclose at least a part of the audio generator and the housing may include a material dense enough to lower direct acoustic radiation from said housing by a minimum of 30 dB.

In some forms of the invention the apparatus may further include a tab attached to the audio generator to facilitate hanging of the audio generator from a junction box screw or other support. The tab may include an elongated slot having first and second axial extremities and said slot is wider at the second axial extremity than at the first axial extremity. The slot may include axial parts having opposed symmetrical arcuate parts thereof. More specifically, the slot may include first and second axial parts having opposed symmetrical arcuate parts thereof. In some cases the apparatus includes

first, second and third axial parts. Having opposed symmetrical arcuate parts thereof.

In some embodiments the audio generator produces audio that sweeps from a first frequency to a higher frequency. The apparatus may include an acoustically conductive connection between the audio generator is and an associated conduit. Some embodiments of the present invention include an acoustically conductive connection includes a stopper dimensioned and configured for engagement with associated conduit. The stopper may have an outer surface for engaging the inner surface of the axial extremity of the associated conduit that includes axially spaced projections. In some embodiments the axially spaced projections have different diameters.

The present invention also includes the method for identifying and locating the remote second axial extremity of a conduit when presented with the first axial extremity of an elongated conduit which includes providing an audio generator having an emitter port having an acoustic amplitude output equal to or greater than 110 dB measured at 2 inches from the emitter port; positioning the emitter port in acoustic communication with the first axial extremity of the conduit; and listening for sound in the potential areas where the second axial extremity of the conduit might be located. The method may include a step of providing an audio generator that includes providing an audio generator that sweeps from a first frequency to a higher frequency.

### BRIEF DESCRIPTION OF THE DRAWINGS

The invention will be better understood by reference to the accompanying drawings in which:

FIG. 1 is an exploded partially schematic view illustrating an embodiment of the apparatus in accordance with the present invention.

FIG. 2 is an exploded partially schematic view illustrating the same embodiment of the present invention as that shown in FIG. 1.

FIG. 3A is a front view of an assembled apparatus in accordance with one form of the present invention.

FIG. 3B is a front view of an assembled apparatus in accordance with one form of the present invention with fitting 1, switch 2 and end cap 4 removed.

FIG. 3C is a partially exploded view of the housing illustrated in FIGS. 3A and 3B.

FIGS. 4A, 4B, and 4C are respective exploded views illustrating embodiments of the present invention and the manner of acoustically coupling that apparatus to an associated conduit.

FIG. 5A is a partially exploded view of an embodiment of the present invention that includes a flange having an opening for suspending the apparatus during use.

FIGS. 5B, 5C, and 5D are respectively bottom, front and side views of a separate flange illustrated in FIG. 5A.

FIGS. 6A, 6B, 6C, and 6D are respectively partially exploded, bottom, front and side views of a similar flange illustrated that is constructed as part of the end cap of the apparatus.

### DESCRIPTION OF THE PREFERRED EMBODIMENTS

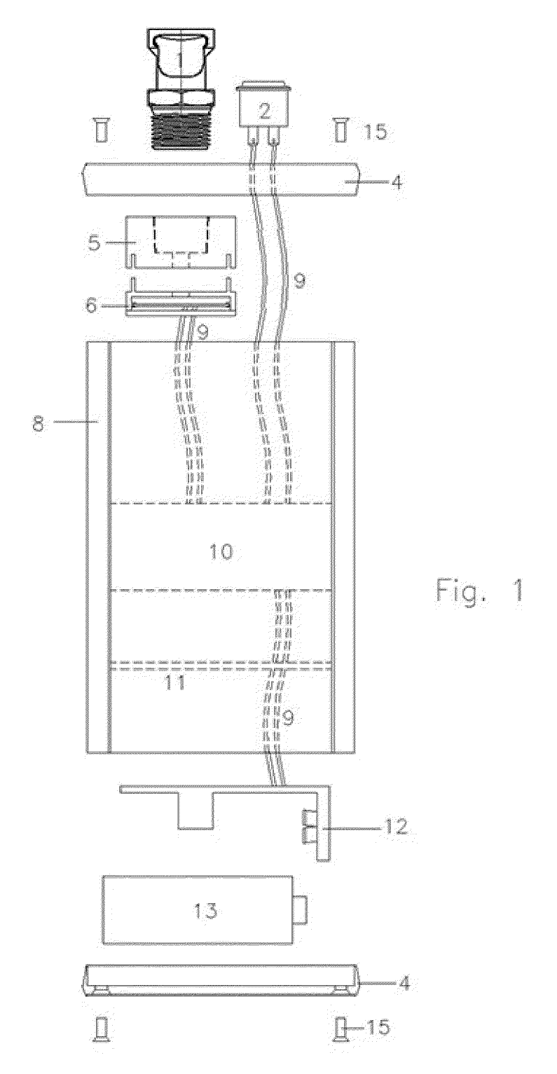

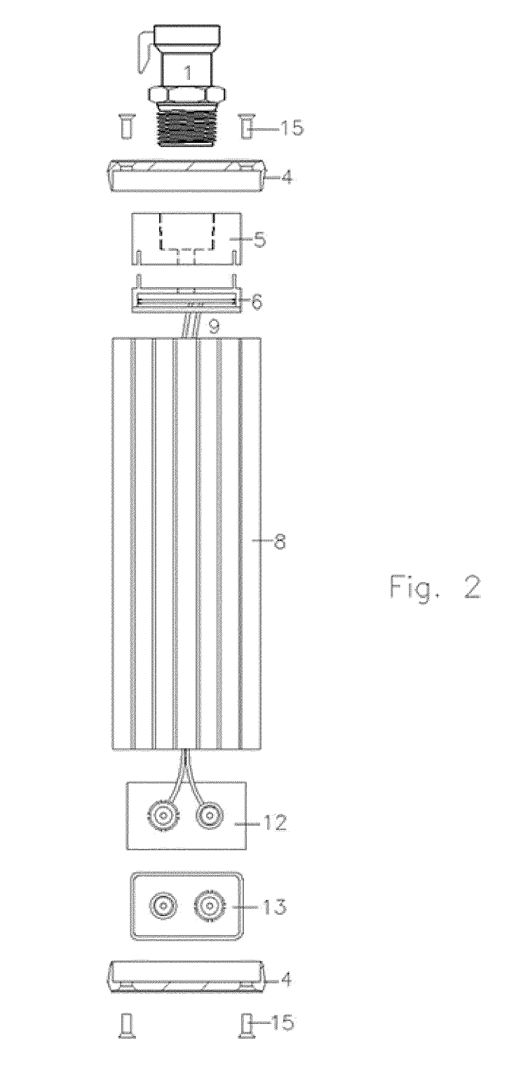

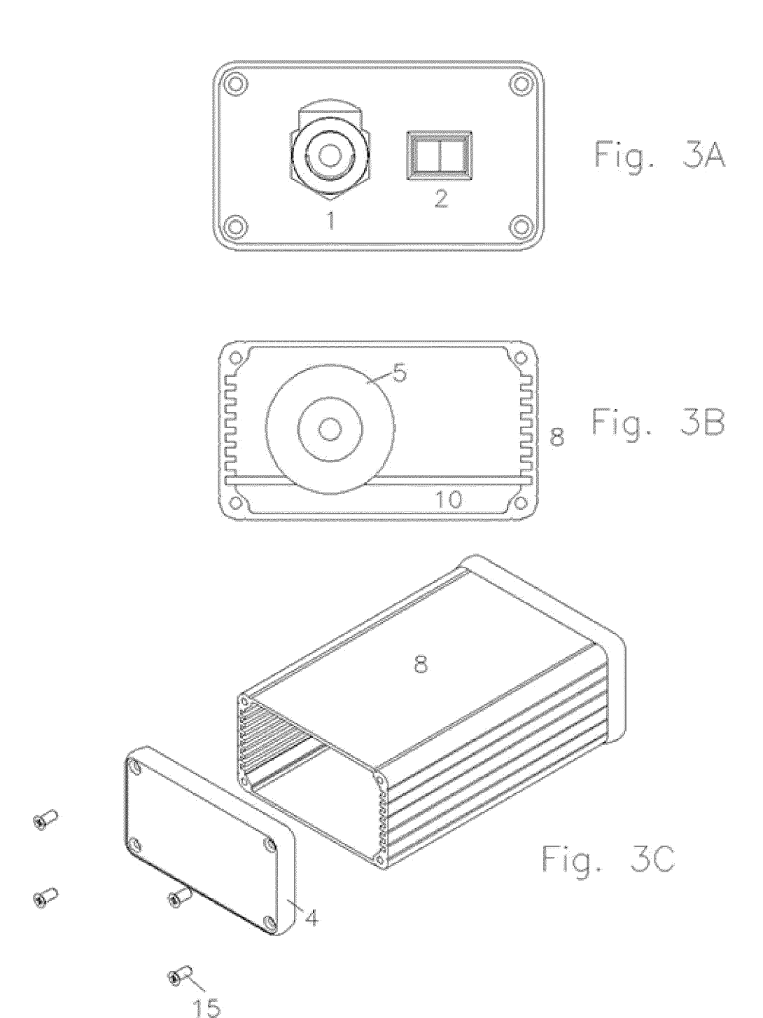

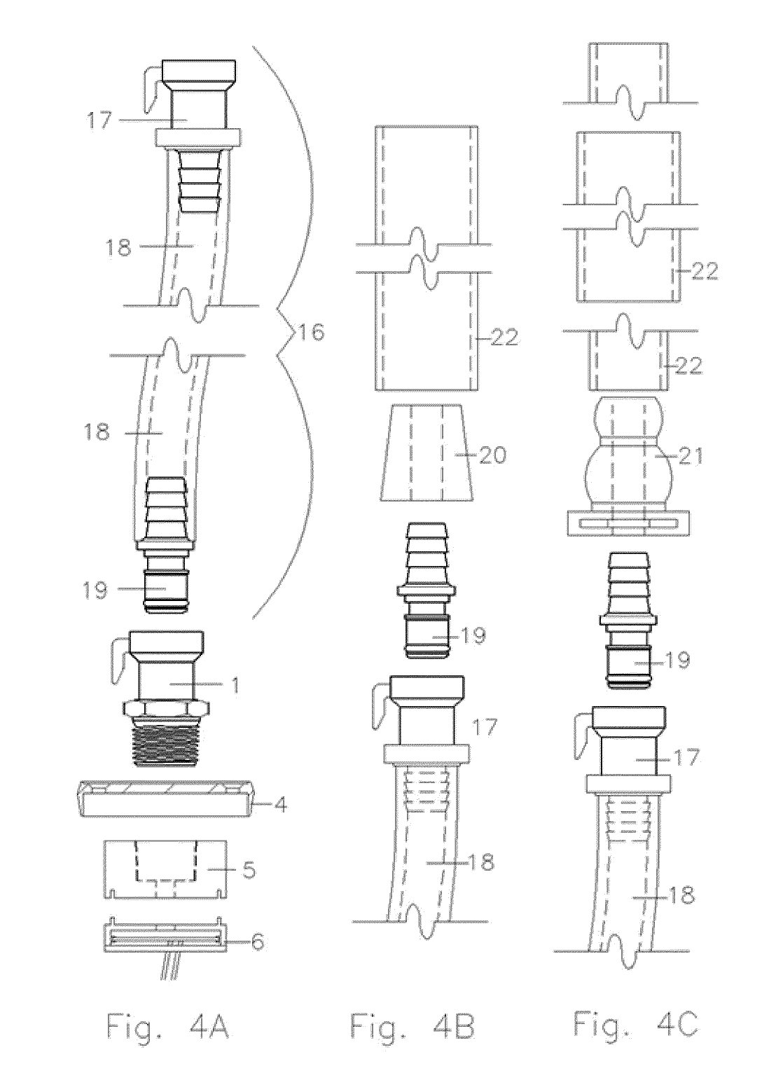

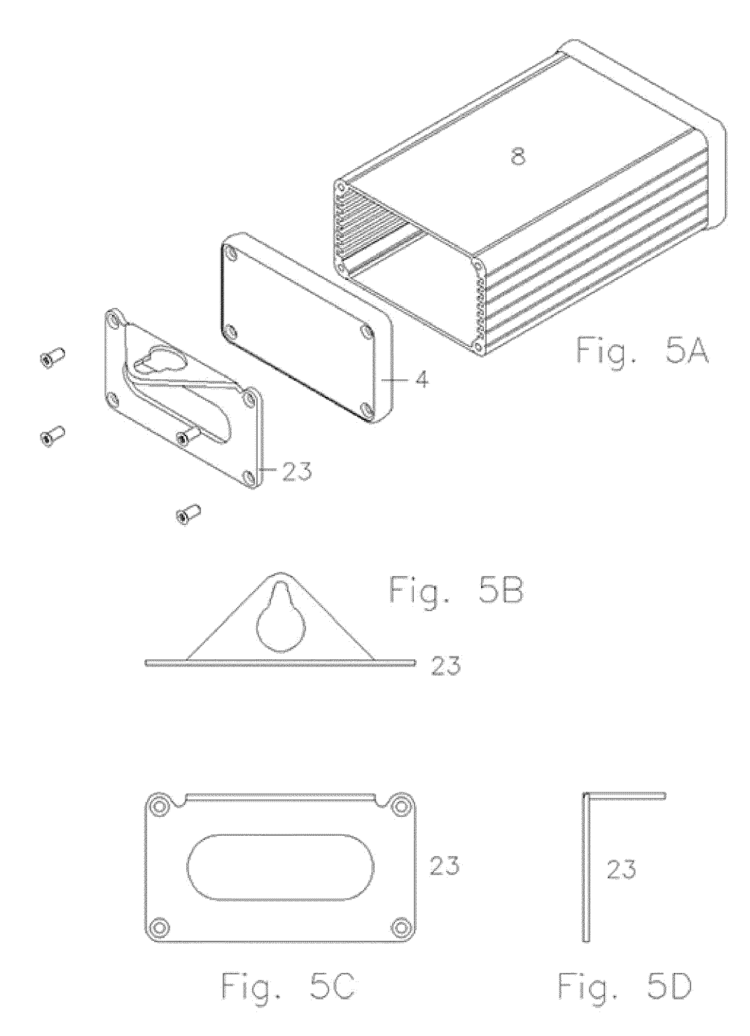

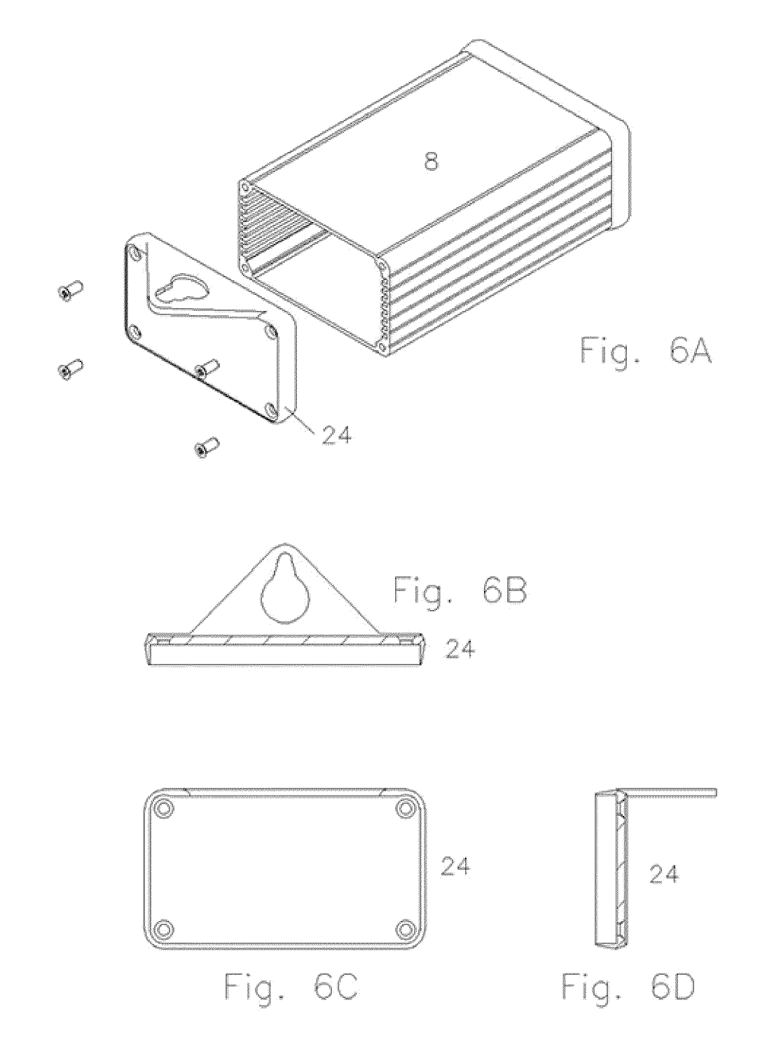

Referring to FIGS. 1-5D, there is shown an embodiment of the present invention that includes a transducer 6 that receives an uncoded, continuous, variable, or swept audio frequency signal from a driver circuit board 10. This frequency would typically be in the most favorable frequency band for human perception—between 200 Hz and 5000 Hz. In one embodiment, the transducer 6 is coupled to an adapter 5 having a female thread dimensioned and configured to accept the male thread of an output fitting 1. In another embodiment, the transducer 6 and adapter 5 are made from a single part. The transducer 6 may be comprised of more than one emitting surface. The fitting 1 may be inserted into adapter 5 through an end cap or bezel 4, which may be attached to the main housing 8 with screws or pop rivets 15. A power switch 2 enables the current from the battery 13 to be conducted to the driver circuit board 10 via the battery holder 12 and connecting wires 9. The battery holder 12 is attached to the housing by a bracket 11. Sound is transmitted from the transducer 6 through the output fitting 1 into the coupling hose assembly 16, which is comprised of a male fitting 19, a female fitting 17, and a connecting hose 18. In one embodiment, a male fitting 19 is inserted into a standard laboratory type stopper 20 made from a resilient material such as rubber or urethane, which is then pressed into the end of a conduit 22. Suitable sizes of stopper 20 are used for different sizes of conduit. In another embodiment, a male fitting 19 is inserted into a ‘stacked ball’ type stopper 21 made from a resilient material such as rubber or urethane. The unit may also be used without the coupling hose by inserting the stopper/male fitting 19/20 assembly directly into the output fitting 1, or by simply using the unit by itself with nothing inserted into the output fitting for use in free air to energize a large space allowing multiple conduits to receive the audio signal simultaneously.

The stopper 20 in some embodiments has single or multiple semi-spherical surfaces that may be separated by short straight sections to enable the gripping part of the stopper to be inserted further into the pipe. The stopper may incorporate a metallic or hard plastic washer to prevent the stopper from being inserted too far into the conduit. This stopper is typically limited to one or two steps in size to allow it to be used in small electrical boxes. Other embodiments may use a plurality of parallel axially spaced flanges such that shown in United Stated design patent Des. 418,417 issued Jan. 4, 2000 and which is incorporated by reference. Those skilled in the art will recognize that the stacked ball description corresponds to the flanges in Des. 418,417 with the only difference being the relative thickness and radius of curvature of the respective flanges. In other embodiments the flanges may by axially tapered in the manner shown in U.S. Pat. No. 8,556,136 issued Oct. 15, 2013 and which is also incorporated by reference. In such embodiments the respective flanges are wedge shaped whereby upon insertion into a conduit the contour opposes easy withdrawal.

The apparatus in accordance with one form of the present invention includes a keyhole slot formed in a bracket 23 attached to the sender unit, or formed into the end cap of the sender unit 24. This slot permits hanging the unit on a junction box cover screw, or a wire attached to something nearby. The attachment point may located on either end of the unit's housing 8. The housing as shown is generally rectangular, however it can be any shape, including triangular, tubular, spherical, or any other shape that provides enough internal volume for the components.

It is noted that the terms “first,” “second,” and the like, as well as “primary,” “secondary,” and the like, herein do not denote any amount, order, or importance, but rather are used to distinguish one element from another, and the terms “a” and “an” herein do not denote a limitation of quantity, but rather denote the presence of at least one of the referenced item. The suffix “(s)” as used herein is intended to include both the singular and the plural of the term that it modifies, thereby including one or more of that term (e.g., the bearings(s) includes one or more bearings). The endpoints of all ranges directed to the same component or property are inclusive and independently combinable (e.g., ranges of “up to about 5°, or, more specifically, about 0.5° to about 3°” is inclusive of the endpoints and all intermediate values of the ranges of “about 0.5° to about 5°,” etc.).

The present invention includes an approach to improve systems and techniques used in construction and renovation of buildings and, more particularly, to systems for facilitating the installation of interior electrical wiring in commercial and residential buildings. A high output acoustic emitter is placed in a housing and coupled to the open end of a conduit with a flexible plastic or rubber hose. Various sized rubber stoppers are used to seal the output to the end of the pipe. Preferably the stoppers are color coded for respective pipe sizes.

When the system is turned on, a high level (>110 dB), uncoded variable frequency tone is sent down the pipe. The tone is confined to the pipe, and as such, could be more accurately described as a pressure wave rather than a sound wave while it is in the pipe. Sound is normally attenuated at 6 dB per every doubling of distance in free air. This does not occur in the confined space of the pipe and as a result, the pressure does not fall off very much, even at distances of 300 feet or more.

When the pressure wave exits the other end of the pipe, it naturally converts from a pressure wave to a sound wave, which is clearly audible for quite long distances without any need for a detector. The system can also be used without directly coupling it to the pipe. This will of course cause a reduction in the sound level emitted from the other end of the pipe, but it is usually still clearly audible, with no need for a detector at the other end. One or more workers can simply walk into an area that they suspect that the far end of the pipe may be located in and listen for the tone. If the tone is heard, they would walk over to the source of the tone. If the tone seems to be coming from a junction box with multiple pipes in it, they can simply plug each pipe until the sound level drops, indicating the correct pipe has been located. The output from the pipe is usually loud enough that the sound can be heard even through an intervening material such as gypsum wall board, or if the conduit happens to end in a closed junction box.

The audio output in some preferred embodiments of the present invention utilize a swept audio frequency signal meaning that the frequency sweeps between a low frequency and a high frequency—like a police siren. The most effective sweep is usually referred to as a ‘yelp’, and sweeps from ˜300 Hz to ˜3 kHz about 2-4 times per second. Other embodiments utilize sequential burst tones. Any type of noise that be easily distinguished from typical ambient sounds will work. Police sirens would qualify as an attention-getting sound, as that is what they are intended to do. Similarly, the sounds produced by personal alarms to scare off muggers are also effective.

The apparatus in accordance with the present invention can also be used with wires in the pipe by removing the plastic coupler from the end of the coupling tube and inserting the tube into the pipe alongside the wires. The wires will reduce the effective range somewhat, however, this approach has enabled location of the correct remote ends of respective pipes several hundred feet long.

The apparatus in accordance with the present invention has uses that extend beyond merely finding the other end of a given conduit. There are situations when it is desirable to allow multiple conduits to receive the audio signal simultaneously. For example; assume that the user is in a communications room that may have several hundred conduits in it, and you don't know which one you want or if any of them will be suitable. You need to find a pipe that goes to another smaller communications room that has 10-20 conduits in it—but only one of them is likely to go to the first communications room. Rather than test every individual conduit, it is much faster to simply place the emitter out in the open in either communications room, then go to the other one and see which pipe you can hear the tone coming from. In an actual experience it turned out that the only pipe found to be useful actually went to the boiler room, but we could still hear it coming through a wiring duct between the boiler room and the main communications room!

It would have been totally impossible to locate that pipe without the apparatus of the present invention. A new pipe would have had to been run, potentially costing thousands of dollars, and possibly causing cosmetic or even structural damage to the building. This happens all the time in the real world. The complications involved in installing new conduits are exemplified by the inventors personal experience where a 4″ diameter slug of concrete that was cored out of a wall for installation of a conduit. In the exact center of the middle of the core is what used to be the main power feed cable for the building from which it was removed. The repairs cost over $20,000 to dig out well over a ton of dirt, smash a huge hole in the wall, install 2 junction boxes and other assorted hardware, re-connect the cable, re-pour the wall, and fill the dirt back in. The apparatus in accordance with the present invention can minimize the need to install new conduits and thus avoid such issues.

The unit housing may also be potted in some embodiments of the invention. Those skilled in electronic manufacturing will understand the housing will accordingly be filled with a potting compound. More specifically the housing may be filled with a urethane rubber compound, epoxy or other amorphous material. This structure focuses the sound output of the device to the emitter port as opposed to radiating from the sides of the enclosure. In the absence of the potting compound, the noise radiating from the sides of the housing was almost as loud as the noise coming out the port. With urethane the problem was solved. The urethane also gives shock & water protection, adds some mass to the unit, and prevents modification of the circuitry.

Most embodiments of the present invention are battery powered.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. Apparatus for use with at least one associated elongated conduit having first and second axial extremities and for facilitating the identification of the location of the second axial extremity of the associated conduit when presented with the first axial extremity thereof which comprises:
an audio generator having an emitter port having an acoustic amplitude output equal to or greater than 110 dB measured at 2 inches from said emitter port.

2. The apparatus as described in claim 1 further including a housing enclosing at least a part of said audio generator, said housing constraining audio output from said audio generator at parts thereof other than said emitter port.

3. The apparatus described in claim 1 further including a housing enclosing at least a part of said audio generator and said housing further including sound insulating substances therein.

4. The apparatus as described in claim 1 further including a housing enclosing at least a part of said audio generator, said housing including a material dense enough to lower direct acoustic radiation from said housing by a minimum of 30 dB.

5. The apparatus as described in claim 1 further including a tab attached to said audio generator to facilitate hanging of said audio generator from a junction box screw or other support.

6. The apparatus as described in claim 5 wherein said tab includes an elongated slot having first and second axial extremities and said slot is wider at said second axial extremity than at said first axial extremity.

7. The apparatus as described in claim 6 wherein said slot includes axial parts having opposed symmetrical arcuate parts thereof.

8. The apparatus as described in claim 6 wherein said slot includes first and second axial parts having opposed symmetrical arcuate parts thereof.

9. The apparatus as described in claim 6 wherein said slot includes first, second and third axial part having opposed symmetrical arcuate parts thereof.

10. The apparatus as described in claim 1 wherein said audio generator that sweeps from a first frequency to a higher frequency.

11. The apparatus as described in claim 1 further including an acoustically conductive connection between said audio generator and an associated conduit.

12. The apparatus as described in claim 11 wherein said acoustically conductive connection includes a stopper dimensioned and configured for engagement with associated conduit.

13. The apparatus as described in claim 12 wherein said stopper has an outer surface for engaging the inner surface of the axial extremity of the associated conduit that includes axially spaced projections.

14. The apparatus as described in claim 13 wherein said axially spaced projections have different diameters.

15. The method for identifying and locating the remote second axial extremity of a conduit when presented with the first axial extremity of an elongated conduit which comprises:
providing an audio generator having an emitter port and an output an acoustic amplitude equal to or greater than 110 dB measured at 2 inches from said emitter port;
positioning the emitter port in acoustic communication with the first axial extremity of the conduit; and
listening for sound in the potential areas where the second axial extremity of the conduit might be located.

16. The method as described in claim 15 wherein the step of providing an audio generator includes providing an audio generator that sweeps from a first frequency to a higher frequency.
